(19) United States
(12) Patent Application Publication
(10) Pub. No.: US 2008/0313647 A1
(43) Pub. Date: Dec. 18, 2008

(54) Thread virtualization techniques

(75) Inventors: Matthew D. Klein, Seattle, WA (US); Paul England, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/820,065

(22) Filed: Jun. 18, 2007

(51) Int. Cl. G06F 13/00

(52) U.S. Cl. 719/313

(57) ABSTRACT

Various technologies and techniques are disclosed for virtualizing threads. An operating system thread is virtualized by intercepting accesses of the operating system thread state and emulating a normal operating system behavior. A kernel mode thread state is virtualized by intercepting kernel accesses of the kernel mode thread state and emulating a normal kernel mode behavior. A user mode thread state is virtualized by intercepting user mode accesses of the user mode thread state and emulating a normal user mode behavior. If the access is a write access, then the write access is applied to a virtual thread structure. If the access is a read access, then the read access is applied to the virtual thread structure.

### BACKGROUND

Over time, computer hardware has become faster and more powerful. For example, computers of today can have multiple processor cores that can operate in parallel. Programmers would like for different pieces of the program to execute in parallel on these multiple processor cores to take advantage of the performance improvements that can be achieved. A high performance parallel application must exert careful control over its execution to optimize the use of hardware caches and interconnects.

However, operating systems of today are limited in their ability to allow applications to control scheduling of their threads. For example, some operating systems of today, such as MICROSOFT® WINDOWS® support two ways for allowing applications to schedule their own execution. The first way is that an application can adjust its thread state (runnable or suspended), the thread priority, etc. However, the time it takes to put one thread to sleep and start another one using this approach is relatively expensive. Furthermore, a user mode thread can only execute on its associated kernel thread. This makes it difficult to use threads to control application execution in parallel and/or other applications.

The second way an application can schedule its own execution is to use fibers. A fiber is a lightweight execution context that can be scheduled entirely in user mode. However, most operating system services are built around threads as opposed to fibers, and these system services are hard to use or do not work at all when called from fibers. Thus, fibers are also difficult to use in controlling application execution in parallel and/or other operations.

### SUMMARY

Various technologies and techniques are disclosed for virtualizing threads. An operating system thread is virtualized by intercepting accesses of the operating system thread state and emulating a normal operating system behavior. A kernel mode thread state is virtualized by intercepting kernel accesses of the kernel mode thread state and emulating a normal kernel mode behavior. A user mode thread state is virtualized by intercepting user mode accesses of the user mode thread state and emulating a normal user mode behavior. If the access is a write access, then the write access is applied to a virtual thread structure. If the access is a read access, then the read access is applied to the virtual thread structure.

In one implementation, kernel mode thread state is virtualized by selecting a kernel thread block associated with a virtual thread and performing the intercepted access using the kernel thread block. In another implementation, user mode thread state is virtualized by selecting a user thread block associated with a virtual thread and performing the intercepted access using the user thread block.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a thread virtualization application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in virtualizing an operating system thread.

FIG. 5 is a process flow diagram for one implementation of the system of FIG. 1 illustrating the stages involved in virtualizing a kernel mode thread state.

FIG. 6 is a process flow diagram for one implementation of the system of FIG. 1 illustrating the stages involved in virtualizing a user mode thread state.

FIG. 7 is a process flow diagram for one implementation of the system of FIG. 1 that illustrates the stages involved in picking a kernel thread to run a user thread.

FIG. 8 is a process flow diagram for one implementation of the system of FIG. 1 that illustrates the stages involved in modifying a kernel thread to run a user-thread.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that enhances operating system thread scheduling, but the system also serves other purposes in addition to these. In one implementation, one or more of the techniques described herein can be implemented as features within an operating system program such as MICROSOFT® WINDOWS®, or from any other type of program or service that manages and/or executes threads.

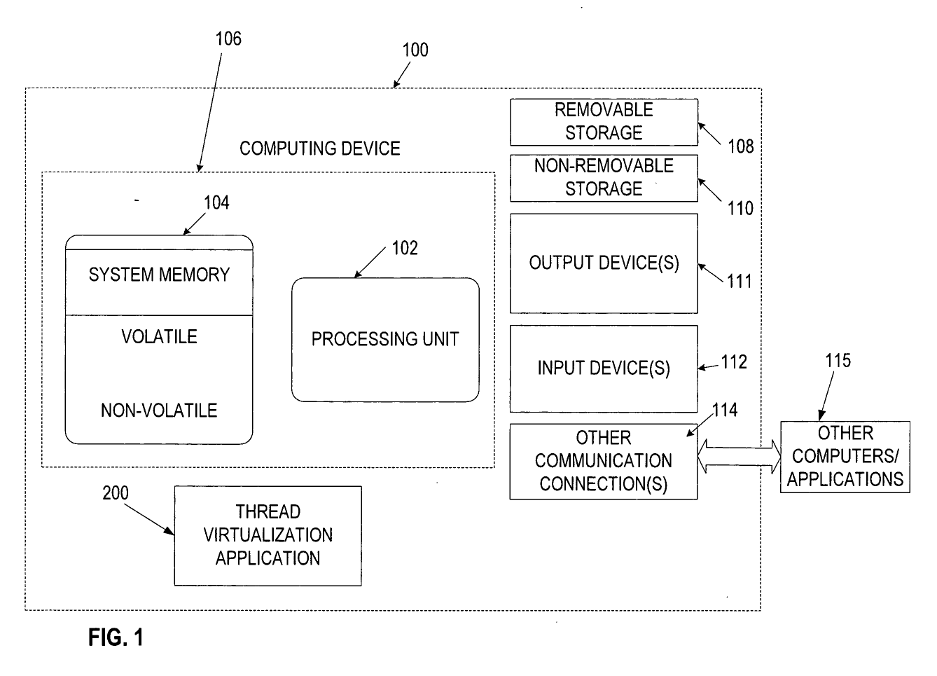

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

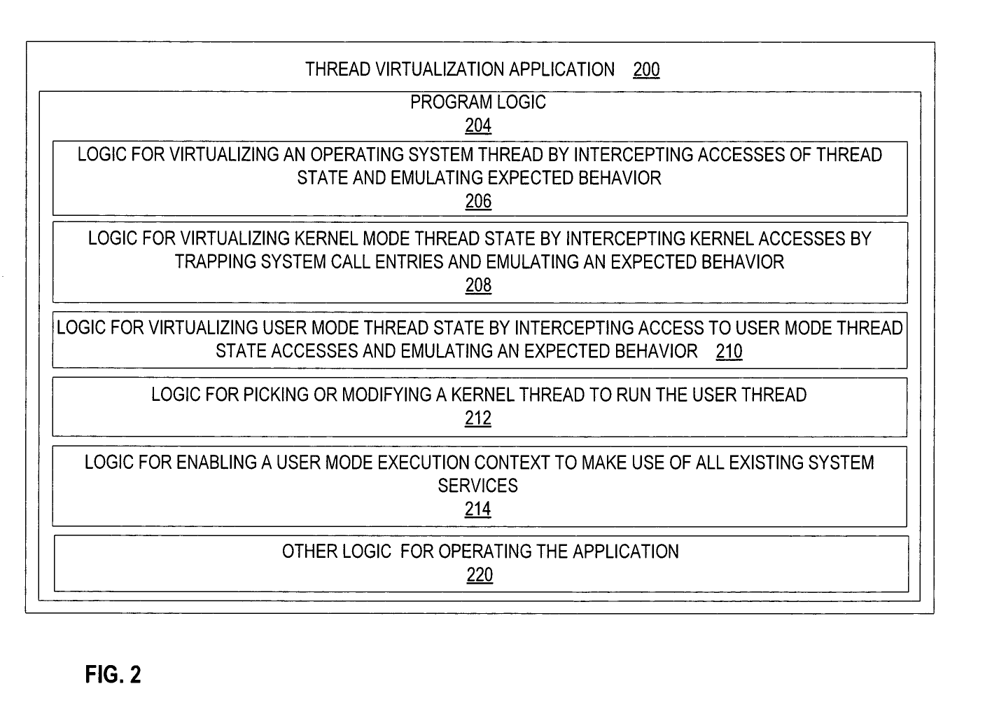

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes thread virtualization application 200. Thread virtualization application 200 will be described in further detail in FIG. 2.

Turning now to FIG. 2 with continued reference to FIG. 1, a thread virtualization application 200 operating on computing device 100 is illustrated. Thread virtualization application 200 is one of the application programs that reside on computing device 100. However, it will be understood that thread virtualization application 200 can alternatively or additionally be embodied as computer-executable instructions on one or more computers and/or in different variations than shown on FIG. 1. Alternatively or additionally, one or more parts of thread virtualization application 200 can be part of system memory 104, on other computers and/or applications 115, or other such variations as would occur to one in the computer software art.

Thread virtualization application 200 includes program logic 204, which is responsible for carrying out some or all of the techniques described herein. Program logic 204 includes logic for virtualizing an operating system thread by intercepting accesses of thread state and emulating an expected behavior 206; logic for virtualizing kernel mode thread state by intercepting kernel accesses by trapping system call entries and emulating an expected behavior 208; logic for virtualizing user mode thread state by intercepting access to user mode thread state accesses and emulating an expected behavior 210; logic for picking or modifying a kernel thread to run the user-thread 22; logic for enabling a user mode execution context to make use of all existing system services 214; and other logic for operating the application 220. In one implementation, program logic 204 is operable to be called programmatically from another program, such as using a single call to a procedure in program logic 204.

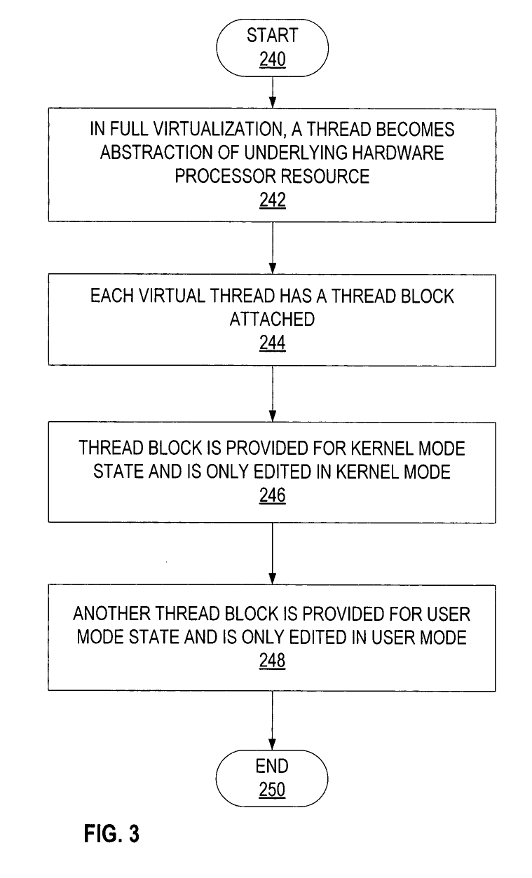

Turning now to FIGS. 3-8 with continued reference to FIGS. 1-2, the stages for implementing one or more implementations of thread virtualization application 200 are described in further detail. FIG. 3 is a high level process flow diagram for thread virtualization application 200. In one form, the process of FIG. 3 is at least partially implemented in the operating logic of computing device 100. The process begins at start point 240 with a thread becoming an abstraction of underlying hardware processor resources in full virtualization (stage 242). Each virtual thread has a thread block attached (stage 244). A thread block is provided for kernel mode state and is only edited in kernel mode (stage 246). Another thread block is provided for user mode state and is only edited in user mode (stage 248). The process ends at end point 250.

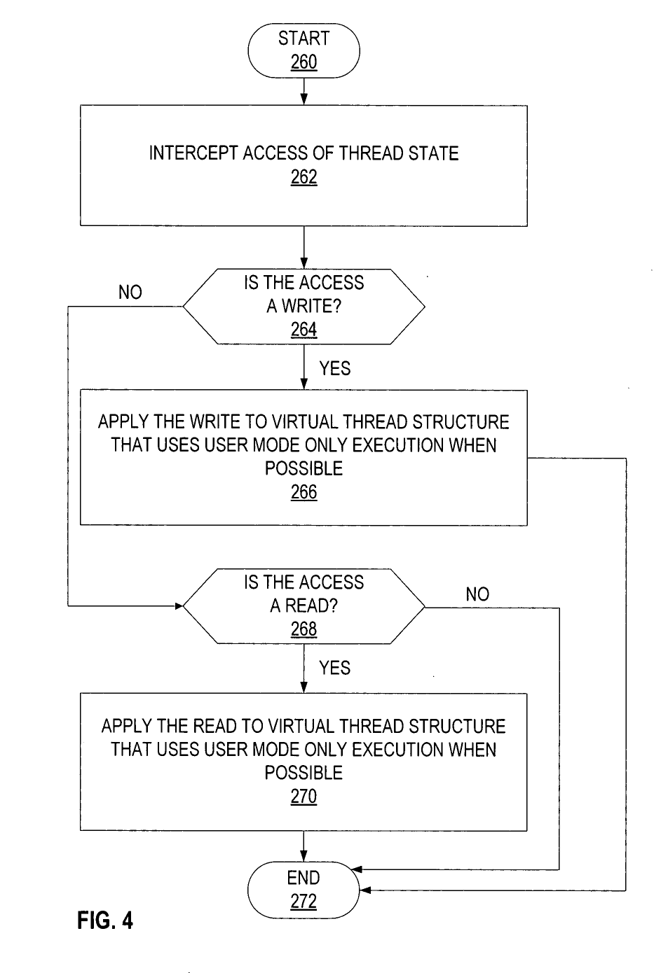

FIG. 4 illustrates one implementation of the stages involved in virtualizing an operating system thread. In one form, the process of FIG. 4 is at least partially implemented in the operating logic of computing device 100. The process begins at start point 260 with intercepting access of operating system threat state (stage 262). If the access is a write (decision point 264), then the write is applied to a virtual thread structure that uses user mode only execution when possible (stage 266). If the access is read (decision point 268), then the read is applied to a virtual thread structure that uses user mode only execution when possible (stage 270). The process ends at end point 272.

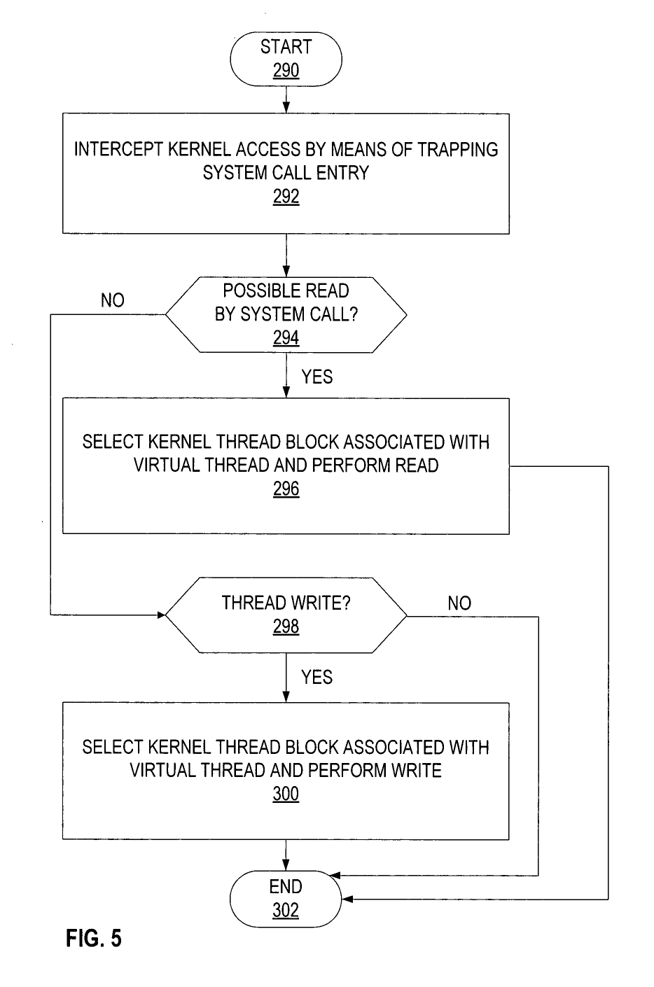

FIG. 5 illustrates one implementation of the stages involved in virtualizing a kernel mode thread state. In one form, the process of FIG. 5 is at least partially implemented in the operating logic of computing device 100. The process begins at start point 290 with intercepting kernel access by means of trapping a system call entry (stage 292). If the access is a read (decision point 294), then the kernel thread block associated with the virtual thread is selected and the read access is performed using the kernel thread block (stage 296). If the access is a write (decision point 298), then the kernel thread block associated with the virtual thread is selected and the write access is performed using the kernel thread block (stage 300). The process ends at end point 302.

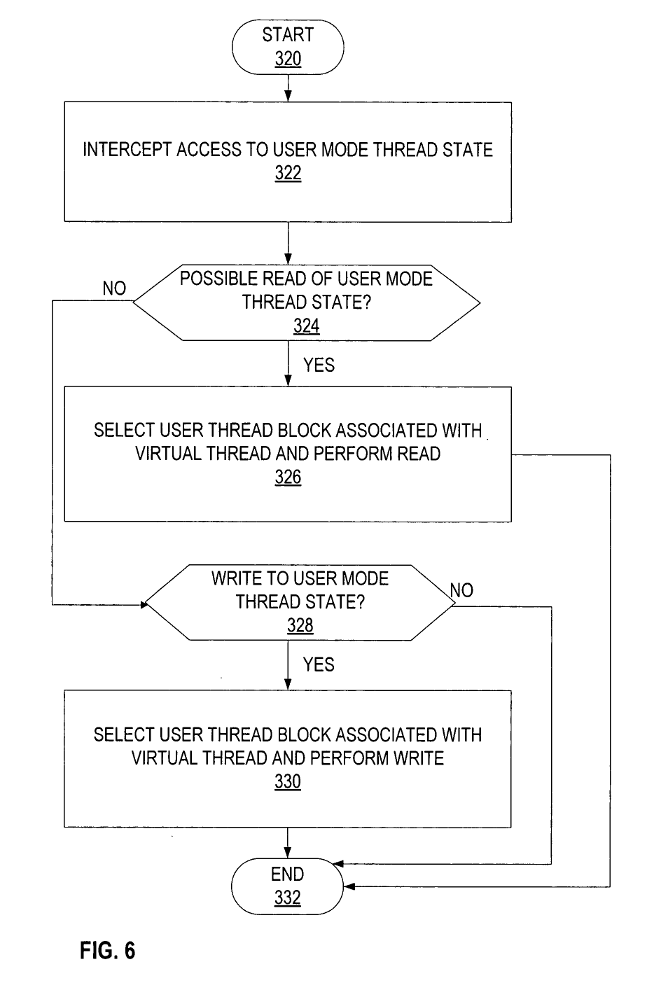

FIG. 6 illustrates one implementation of the stages involved in virtualizing a user mode thread state. In one form, the process of FIG. 6 is at least partially implemented in the operating logic of computing device 100. The process begins at start point 320 with intercepting an access to the user mode thread state (stage 322). If the access is a read (decision point 324), then the user thread block associated with the virtual thread is selected and the read access is performed using the user thread block (stage 326). If the access is a write (decision point 328), the thread block associated with the virtual thread is selected and the write access is performed using the user thread block (stage 330). The process ends at end point 332.

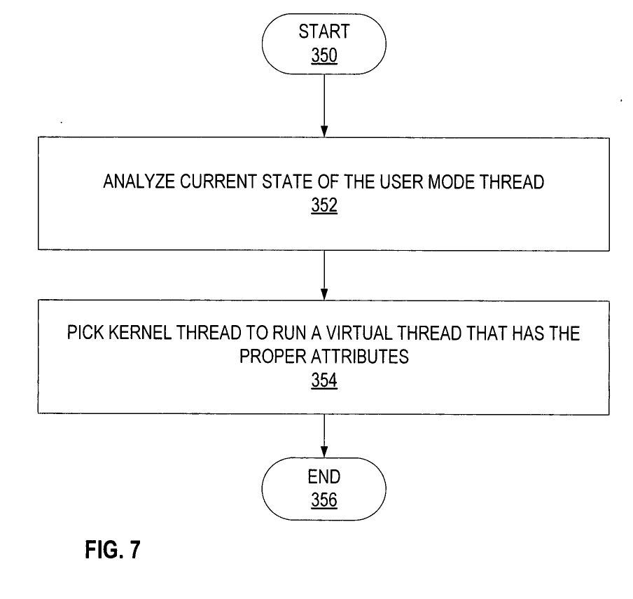

FIG. 7 illustrates one implementation of the stages involved in selecting a kernel thread to run a user thread. In one form, the process of FIG. 7 is at least partially implemented in the operating logic of computing device 100. The process begins at start point 350 with the system analyzing the current state of the user mode thread (stage 352). The system selects a kernel thread to run a virtual thread that has the proper attributes based on a current virtualized state of the user thread (stage 354). The process ends at end point 356.

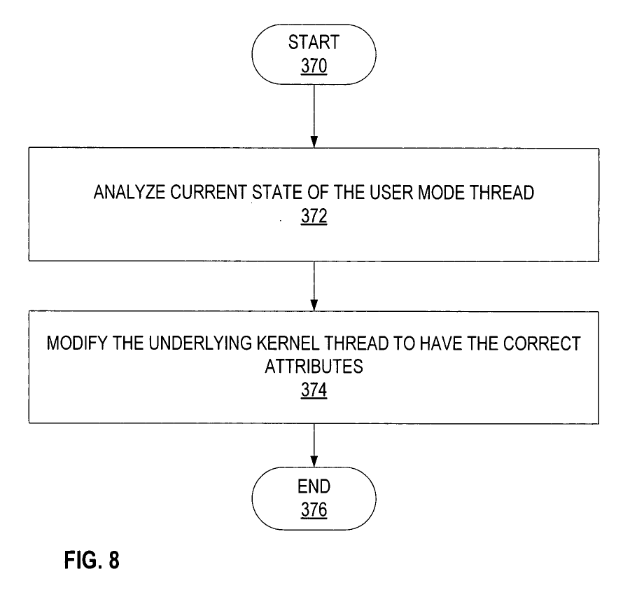

FIG. 8 illustrates one implementation of the stages involved in modifying a kernel thread to run a user thread. In one form, the process of FIG. 8 is at least partially implemented in the operating logic of computing device 100. The process begins at start point 370 with the system analyzing the current state of the user mode thread (stage 372). The system modifies the underlying kernel thread to have the correct attributes based on a current virtualized state of the user thread (stage 374). The process ends at end point 376.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
virtualize an operating system thread by intercepting accesses of the operating system thread state and emulating a normal operating system behavior;
virtualize a kernel mode thread state by intercepting kernel accesses of the kernel mode thread state and emulating a normal kernel mode behavior; and
virtualize a user mode thread state by intercepting user mode accesses of the user mode thread state and emulating a normal user mode behavior.

2. The computer-readable medium of claim 1, further having computer-executable instructions for causing a computer to perform steps comprising:
select a kernel thread to run a user thread based on a current virtualized state of the user thread.

3. The computer-readable medium of claim 1, further having computer-executable instructions for causing a computer to perform steps comprising:
modify a kernel thread to run a user thread based on a current virtualized state of the user thread.

4. The computer-readable medium of claim 1, further having computer-executable instructions for causing a computer to perform steps comprising:
enable a user mode execution context to make use of all system services.

5. The computer-readable medium of claim 1, wherein the kernel mode thread state is virtualized by trapping system call entries.

6. The computer-readable medium of claim 1, wherein a read of operating system thread state is virtualized by applying the read to a virtual thread structure.

7. The computer-readable medium of claim 1, wherein a write of operating system thread state is virtualized by applying the write to a virtual thread structure.

8. The computer-readable medium of claim 1, wherein a read of kernel mode thread state is virtualized by selecting a kernel thread block associated with a virtual thread and performing the read from the kernel thread block.

9. The computer-readable medium of claim 1, wherein a write of kernel mode thread state is virtualized by selecting a kernel thread block associated with a virtual thread and performing the write from the kernel thread block.

10. The computer-readable medium of claim 1, wherein a read of user mode thread state is virtualized by selecting a user thread block associated with a virtual thread and performing the read from the user thread block.

11. The computer-readable medium of claim 1, wherein a write of user mode thread state is virtualized by selecting a user thread block associated with a virtual thread and performing the write from the user thread block.

12. The computer-readable medium of claim 1, wherein a virtual thread structure is used for the virtualization of the operating system thread state, the kernel mode thread state, and the user mode thread state.

13. The computer-readable medium of claim 12, wherein the virtual thread structure uses user mode execution when possible.

14. A method for virtualizing an operating system thread comprising the steps of:
intercepting an access of operating system thread state;
if the access is a write access, then applying the write access to a virtual thread structure; and
if the access is a read access, then applying the read access to the virtual thread structure.

15. The method of claim 14, wherein the virtual thread structure uses user mode execution when possible.

16. A computer-readable medium having computer-executable instructions for causing a computer to perform the steps recited in claim 14.

17. A method for virtualizing a thread state comprising the steps of:
intercepting an access to thread state; and
selecting a thread block associated with a virtual thread and performing the intercepted access using the thread block.

18. The method of claim 17, wherein the access is a kernel access to kernel mode thread state, and wherein the thread block is a kernel thread block.

19. The method of claim 17, wherein the thread state is user mode thread state, and wherein the thread block is a user mode thread block.

20. A computer-readable medium having computer-executable instructions for causing a computer to perform the steps recited in claim 17.
